(19) United States
(12) Patent Application Publication
(10) Pub. No.: US 2024/0082857 A1
(43) Pub. Date: Mar. 14, 2024

(54) A SWIRL NOZZLE AND METHODS OF FABRICATING THE SAME

(71) Applicant: BonSens AB, Lidingö (SE)

(72) Inventors: Torben Last, Sollentuna (SE); Niclas Roxhed, Bromma (SE); Göran Stemme, Lidingö (SE)

(21) Appl. No.: 18/261,978

(22) PCT Filed: Jan. 18, 2022
(86) PCT No.: PCT/EP2022/050982

§ 371 Date: Jul. 18, 2023

(30) Foreign Application Priority Data
Jan. 18, 2021 (SE) 21300181

(51) Int. Cl. B05B 1/34; B33Y 80/00

(52) U.S. Cl. CPC B05B 1/3426; B33Y 80/00; B29C 64/124

(57) ABSTRACT

A method for forming a monolithic swirl nozzle configured to aerosolize a pharmaceutical drug. The swirl nozzle comprises an inlet for receiving the pharmaceutical drug to be aerosolized; a swirl chamber connected to the inlet and configured to aerosolize the pharmaceutical drug provided by the inlet; and an outlet connected to the swirl chamber and configured to discharge the aerosolized pharmaceutical drug. The method comprises providing a photoactivatable material and forming the swirl nozzle by selectively activating voxels in the photoactivatable material.

### TECHNICAL FIELD

The present invention generally relates to swirl nozzles for aerosolization, specifically for aerosolization of pharmaceutical drugs, as well as methods for fabricating such swirl nozzles.

### BACKGROUND

Swirl nozzles can be used to facilitate the dispersion of liquid into a spray and are used in many different applications, ranging from the injection of fuel into engines to agricultural uses, and for aerosolization of medical drugs, such as nasal sprays.

Swirl nozzles require high pressure to achieve sufficiently small aerosol droplets, typically in the range of 10 bar and more. Mechanically tough materials such as metals have therefore been used as base materials for the high-pressure operation of swirl nozzles. When the nozzle unit is used as a fuel injector, it further must stand high temperatures. These nozzle units are in the size range of millimeters to centimeters.

Aerosolization of medical drugs is one of the frontiers of current research and could enable novel lung disease treatments. Applications range from vaccine delivery to cancer treatments to gene therapy.

However, when used for the aerosolization of medical drugs, the aerosolization requirements are different compared to other uses. For example, the swirl nozzle may need to be able to deliver drugs that are mechanically fragile, i.e., sensitive to high shear rates.

Thus, it would be desirable to provide improved methods for forming swirl nozzles suitable for the delivery of pharmaceutical drugs.

### SUMMARY

It is an object of the present invention to provide alternative and/or improved methods for manufacturing swirl nozzles.

The inventive concept generally relates to a monolithic swirl nozzle configured to aerosolize a pharmaceutical drug. The swirl nozzle comprises an inlet configured to receive the pharmaceutical drug, which is to be aerosolized. The swirl nozzle further comprises a swirl chamber connected to the inlet. The swirl chamber is configured to aerosolize the pharmaceutical drug provided by the inlet, and to discharge the aerosolized pharmaceutical drug via an outlet connected to the swirl chamber.

In a first aspect of the inventive concept, there is provided a method for forming such a monolithic swirl nozzle. The method comprises providing a photoactivatable material and forming the swirl nozzle by selectively activating voxels in the photoactivatable material.

In a second aspect of the inventive concept, there is provided a monolithic swirl nozzle formed by the method according to the first aspect of the inventive concept.

In a third aspect of the inventive concept, there is provided a monolithic swirl nozzle configured to aerosolize a pharmaceutical drug. The swirl nozzle comprises an inlet for receiving the pharmaceutical drug to be aerosolized. The swirl nozzle further comprises a swirl chamber connected to the inlet configured to aerosolize the pharmaceutical drug provided by the inlet, and an outlet connected to the swirl chamber and configured to discharge the aerosolized pharmaceutical drug.

In a fourth aspect of the inventive concept, there is provided a medical device for administering a pharmaceutical drug. The medical device comprises a swirl nozzle according to the present invention, and a container, for storing the pharmaceutical drug, connected to the swirl nozzle.

The present inventive concept is based on the idea of providing a monolithic swirl nozzle for aerosolization, and delivery, of a pharmaceutical drug. By the term “swirl nozzle” it is here generally meant a device which exploits a radial acceleration from a vortex in the nozzle to form a circulating, thin liquid cone, which breaks up into droplets. The pharmaceutical drug may be any type of medicament, medicine, medicinal drug or simply drug, used to diagnose, cure, treat, or prevent medical conditions.

The swirl nozzle is advantageous in that it allows delivery of pharmaceutical and/or biological drugs, e.g. to the lungs via an inhaler. Comparatively, less viscous friction is needed to break up the pharmaceutical drug and create an inhalable aerosol. Less friction in turn results in a lower fluidic resistance of the swirl nozzle, leading to shorter spray times, compared to current propellant-free devices such as Rayleigh or Colliding-Jet aerosolization.

The swirl nozzle is further advantageous in that it may be formed in a single piece, i.e. be monolithic, which e.g. improves structural stability and provides a more efficient manufacturing processes since there is no need to make, handle and assemble multiple parts.

It will be appreciated that the swirl nozzle is formed in a manner which allows it to be manufactured to a relatively small size, with features as small as 20 μm or less. It will be further appreciated that the swirl nozzle can handle high operating pressures of up to 35 bar, even at these relatively small sizes.

The swirl nozzle is further advantageous in that it is suitable for aerosolizing liquids with relatively high viscosity, since the design of the swirl nozzle provides a relatively high flow velocity for liquids with higher viscosity.

The swirl nozzle may be formed by means of additive manufacturing, or 3D printing, utilising processes in which material is deposited, joined or solidified under computer control to create a three-dimensional object. Preferably, material (such as polymers, liquids or powder grains that are fused together) may be added layer by layer.

According to some aspects, the swirl nozzle may be formed from a photoactivatable material, which may be selectively activated in chosen voxels during the forming of the nozzle. By the term “photoactivatable material” it is here meant materials that are responsive to light stimuli and undergo photochemical reactions or light-triggered physical processes. For example, a photoactivatable material may be hardened or cured when exposed to photons (light).

In other words, a swirl nozzle according to the present inventive concept may be formed by activating a photoactivatable material, which provides a higher manufacturing precision, allowing very small features to be manufactured in a convenient and versatile manner, while still being structurally stable due to its monolithic design.

According to some embodiments, the photoactivatable material comprises a material selected from a list consisting of: polymers, epoxies, ceramics, metals, or composites thereof. Surprisingly, swirl nozzles formed of polymeric materials have shown to be capable of handling unexpectedly high pressures, such as 10 bars and above, and in some cases even 35 bars or more. These high pressures are normally associated with nozzles formed of metallic or ceramic materials, which often are more expensive and require more complex manufacturing processes compared to polymeric materials. Possibly, the surprisingly good strength properties may be related to the scaled-down physical dimensions of the nozzle required when operating as an aerosolizer of pharmaceutical drugs.

According to some embodiments, the photoactivatable material comprises a ceramic or metallic material suspended in a matrix of the photoactivatable material. Ceramic and metallic materials may be employed to improve the mechanical strength and durability of the swirl nozzle.

According to some embodiments, voxels of the photoactivatable material are selectively activated using two-photon polymerization, which is advantageous since it allows voxels to be activated in a precise and controlled manner at high resolution, and provides a faster fabrication time of the swirl nozzle.

According to some embodiments, the pharmaceutical drug to be aerosolized is a liquid suspension or a liquid solution, which is preferred both for aerosolization and delivery reasons.

According to some embodiments, the swirl nozzle may comprise one or more inlets, and/or one or more outlets. The swirl nozzle may preferably comprise three inlets and a single outlet, for further improving the aerosolization and delivery of the pharmaceutical drug. The one or more outlets may comprise an outlet structure with a gradually increasing hydraulic diameter. By the term “hydraulic diameter” it is here meant the ratio between the wet cross-sectional area, i.e. the internal cross sectional area, and the wet perimeter of conduit of a liquid, wherein the larger the hydraulic radius, the greater the flow. By “wet” it is here referred to as something formed at least partially of liquid and/or moisture.

According to some embodiments, the swirl chamber comprises channels, wherein the channels are configured to create a swirling motion in a stream of the pharmaceutical drug from the inlet to the outlet, such that the pharmaceutical drug is aerosolized.

According to some embodiments, the swirl nozzle comprises a shape, in a cross-section through the discharge direction from the outlet, selected from a list consisting of: circular, elliptical, square, and rectangular.

According to some embodiments, a plurality of voxels are activated simultaneously, which may increase the manufacturing speed of the swirl nozzle and/or improve the efficiency of the manufacturing. This may be achieved by e.g. increasing a number of lasers used for the photoactivation, thereby allowing activation of more than one voxel at a time.

According to some embodiments, a plurality of swirl nozzles are formed in parallel or in series to further increase the manufacturing speed of the swirl nozzle and/or improve the efficiency of the manufacturing. For example, a plurality of swirl nozzles may be formed in parallel by activating a plurality of voxels simultaneously. It is to be understood that a plurality of swirl nozzles may be formed in parallel and in series, essentially manufacturing a series or groups of swirl nozzles in e.g. an array structure.

According to some embodiments, the forming comprises a first forming stage, or step, and a second forming stage, wherein the first stage comprises forming at least part of the nozzle by selectively activating voxels in the photoactivatable material and the second forming stage comprises an additional curing step. The additional curing step may for example be employed to cure parts of the nozzle which were not entirely cured during the first forming stage. By the term “curing” it is here meant a process which toughens and/or hardens a material, such as a liquid solution.

According to some embodiments, the method further comprises removing non-activated photoactivatable material, which may reduce the risk of defects in a surface of the swirl nozzle. Removing excess, uncured (i.e., non-activated) photoactivatable material may further improve mechanical stability of the swirl nozzle.

According to some embodiments, the swirl nozzle may be formed on a holder, or fixated on a holder. The holder may for instance comprise a glass slide. The fixating may comprise using at least one of a polymeric glue, epoxy, UV-curing epoxy, and any glue. Alternatively, or additionally, the fixating may comprise selectively activating photoactivatable material.

According to some embodiments, selectively activating a voxel in the photoactivatable material comprises exposing the voxel to photons in the ultraviolet range of 100-400 nm.

According to some embodiments, the swirl nozzle comprises a width of 4 mm or less and/or a height in the range of 0.1-1 mm. Additionally, the maximum outer width of the nozzle may be less than 4 mm. Generally, it has been observed that scaling down the size of the nozzle may improve tensile strength.

According to some embodiments, the outlet has a diameter in the range of 10-500 μm. Further, the inlet may comprise a channel with a height in the range of 20-500 μm, which may allow spray actuation in a faster manner at high pressures, e.g. of up to 35 bar.

According to some embodiments, a volume of the material forming the swirl nozzle is less than 25 mm³, which may further improve tensile strength.

Further objectives of, features of, and advantages with the present invention will become apparent when studying the following detailed disclosure, the drawings, and the appended claims. Those skilled in the art realize that different features of the present invention, even if recited in different claims, can be combined in embodiments other than those described in the following.

### BRIEF DESCRIPTION OF THE DRAWINGS

This and other aspects of the present invention will now be described in more detail, with reference to the appended drawings showing embodiment(s) of the invention.

FIG. 1 schematically shows a cross section of a swirl nozzle according to exemplifying embodiments of the present invention.

FIG. 2 schematically shows a perspective view of a swirl nozzle according to exemplifying embodiments of the present invention.

FIG. 3 schematically shows an array of swirl nozzles according to exemplifying embodiments of the present invention.

FIG. 4 schematically shows a medical device for administering a pharmaceutical drug, comprising a swirl nozzle according to exemplifying embodiments of the present invention.

FIG. 5 schematically shows a method for forming a monolithic swirl nozzle according to exemplifying embodiments of the present invention.

### DETAILED DESCRIPTION

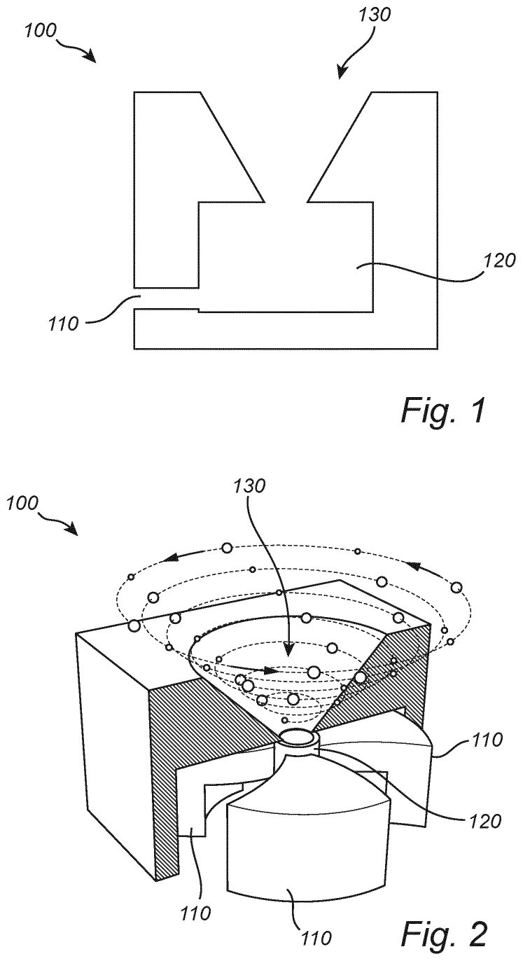

FIG. 1 schematically shows a swirl nozzle 100 according to exemplifying embodiments of the present invention. The swirl nozzle 100 comprises an inlet connected to a swirl chamber 120 and is configured to receive the pharmaceutical drug and direct the pharmaceutical drug to the swirl chamber 120. The swirl nozzle 100 further comprises an outlet 130, which may be connected to the swirl chamber 120 (or form part of the swirl chamber 120). The swirl chamber 120 may be configured to receive the pharmaceutical drug from the swirl chamber 120 and to discharge the aerosolized pharmaceutical drug from the swirl nozzle 100 via the outlet 130. Although only one inlet 110 and one outlet 130 are illustrated in the present cross section, it will be appreciated that the swirl nozzle 100 may comprise more than one inlet 110 and/or more than one outlet 130.

The pharmaceutical drug may be a liquid suspension or a liquid solution, suitable to be aerosolized. The swirl chamber 120 and the outlet 130 may separately, or in combination, be configured to create a swirling vortex of the pharmaceutical drug, e.g. as a liquid solution, in order to aerosolize the pharmaceutical drug and form a spray cone out through the outlet, which breaks up into small aerosol droplets, in order to deliver the pharmaceutical drug, e.g. to a patient.

The swirl nozzle 100 may in some examples be formed by an additive manufacturing method, also referred to as 3D printing, in which a material is gradually added (such as for instance layer by layer) to the structure that is being formed. The additive manufacturing method may for instance involve a photoactivatable material, in which voxels may selectively activated in order to define the features of the swirl nozzle. The photoactivatable material may comprise at a polymer, such as epoxy resin, from which the nozzle may be formed. The polymeric material may further comprise suspended particles, such as ceramic or metallic particles, which may be sintered together to form the nozzle.

Contrary to what one might expect, typical polymers have shown to be capable of fulfilling the strength requirements when the nozzle is sufficiently scaled down. In a study performed by the inventors, load characteristics on an epoxy resin (4.79 E9 Pa Young's modulus, a density of 1.35e3 kg/m3, and a Poisson ratio of 0.3) were approximated by modeling a swirl nozzle structure using a fluid-structure interaction with a turbulent k-ω-model coupled to the solid mechanics' module in a stationary simulation. The equivalent maximum tensile stress was found to be in the range of 30 MPa, with a maximum value of 52 MPa in stress concentration points on the corners of the inlet channel.

In a study performed by the inventors, Nanoscribe IP-S resin was used, which is considered to be non-cytotoxic in direct contact with tissue according to ISO10993-5. The mechanical properties of the material generally depend on the printing parameters and development conditions. For the IP-S resin, the Young's modulus is given by the manufacturer as 4.68 GPa, when printed as a shell. That is less than one-tenth of the value of typical glasses (45-126 GPa) but comparable to other epoxies that cure via free-radical polymerization. Thermosets that also cure via free-radical polymerization with similar Young's modulus (3.3 GPa) are known to have tensile strengths of approximately 70 MPa. Consequently, a swirl nozzle 100 according to the inventive concept, formed by means of additive manufacturing of a polymeric material, is capable of handling surprisingly high pressures and stress concentrations, especially compared to the inherent mechanical properties of the bulk material as such.

The present inventive concept further allows for a plurality of swirl nozzles 100 to be formed in parallel or in series. For a parallel forming of nozzles, a plurality of voxels may be activated simultaneously.

Furthermore, one or more swirl nozzles may be formed on a holder, for example a glass slide (not shown). Alternatively, the swirl nozzle(s) may be fixated on a holder after, and/or while, being formed. The fixating may comprise using at least one of a glue, e.g. a polymeric glue, epoxy and UV-curing epoxy. Another option for fixating is to selectively activate photoactivatable material in the interface between the swirl nozzle and the holder, in order to fixate the swirl nozzle to the holder. After the swirl nozzle(s) has been formed on the holder, the swirl nozzle(s) may be separated from the glass slide.

Furthermore, the outlet 130 may comprise an outlet structure with a gradually increasing hydraulic diameter. For example, the outlet structure may have the shape of a cone which increases in diameter the further out from the centre of the swirl nozzle 100 you go.

It is to be understood that since the swirl nozzle 100 is monolithic, the different parts of it may be seen as part of a single unit and different parts may together have a certain function. For example, the outlet 130 and the swirl chamber 120 may together aerosolize the pharmaceutical drug. Hence, the outlet 130 may form part of the swirl chamber 120.

In FIG. 1, the cross-section through the discharge direction from the outlet has a rectangular shape. In other words, the overall shape of the swirl nozzle 100 viewed from the outside is rectangular. Alternatively, the shape may be circular, elliptical or square instead.

The sizes and volumes of the swirl nozzle may vary. The volume of the solid parts of the swirl nozzle may be less than 25 mm³, or less than 5 mm³, or less than 1 mm³, or 0.0715 mm³ and smaller. The swirl nozzle 100 may have a side length of 4 mm or less, such as 2 mm or less, such as 1 mm or less. In a particular example, the side length of the swirl nozzle 100 may be about 0.5 mm. The height of the swirl nozzle 100 may be smaller or larger than the side length. In particular, the height may be in a range of 0.1-1 mm. The corners of the swirl nozzle 100 may in some examples be rounded. The outlet 130 may have a diameter of 10-500 μm, such as 50-100 μm, such as about 80 μm. The inlet may have an inlet channel height of 20-500 μm, such as about 50 μm. An inlet height of 50 μm has shown to yield a fluidic resistance that allows spray actuation in <300 ms at 35 bar.

In some examples, the swirl nozzle 100 may be formed as a rectangle with dimensions of 1 mm (first side length)×1 mm (second side length)×0.6 mm (height). Such a swirl nozzle 100 has in a study been produced in about 4 minutes, using a two-photon polymerization production method.

The polymeric, monolithic swirl nozzle 100 may operate at a pressure of 10-35 bar and achieve mean volumetric particle size of 12.5 μm with doses of the pharmaceutical drug of 100 μl at aerosolization speeds of 270 ms, a speed suitable for propellant-driven inhalers.

The swirl chamber 120 and/or the outlet 130 may comprise a conical/cone shape, and the diameter of the conical/cone shape may affect the mean outlet velocity. The mean outlet velocity may increase with the diameter of the conical/cone shape until a value of 70 μm. As further increases in the diameter of the conical/cone shape do not affect mean outlet velocity, the main fluidic resistance of the swirl nozzle 100 does not reside in e.g. the outlet 130 or the swirl chamber 120 and its channels, but in the inlet 110. Viscous friction in the inlet is required to generate sufficient velocity to form a swirling vortex in the nozzle outlet. Viscous friction inside the swirl chamber 120 and/or the outlet 130 would slow this swirling motion, decreasing the radial velocity component. Since the fluidic resistance is dictated by the inlet 110, an increase in diameter of the swirl chamber 120 and/or the outlet 130, and therefore outlet area, can potentially decrease the maximum outlet velocity.

FIG. 2 schematically shows a swirl nozzle 100 according to exemplifying embodiments of the present invention, which may be similarly configured as the above swirl nozzle described with reference to FIG. 1. The present swirl nozzle 100 comprises three inlets 110 connected to a swirl chamber 120. The swirl chamber 120 is connected to an outlet 130. The swirl nozzle 100 exploits a radial acceleration from a vortex created by the swirl chamber 120 and/or the outlet 130, in order to aerosolize the pharmaceutical drug and discharge a circulating, thin cone of the aerosolized pharmaceutical drug in the form of droplets.

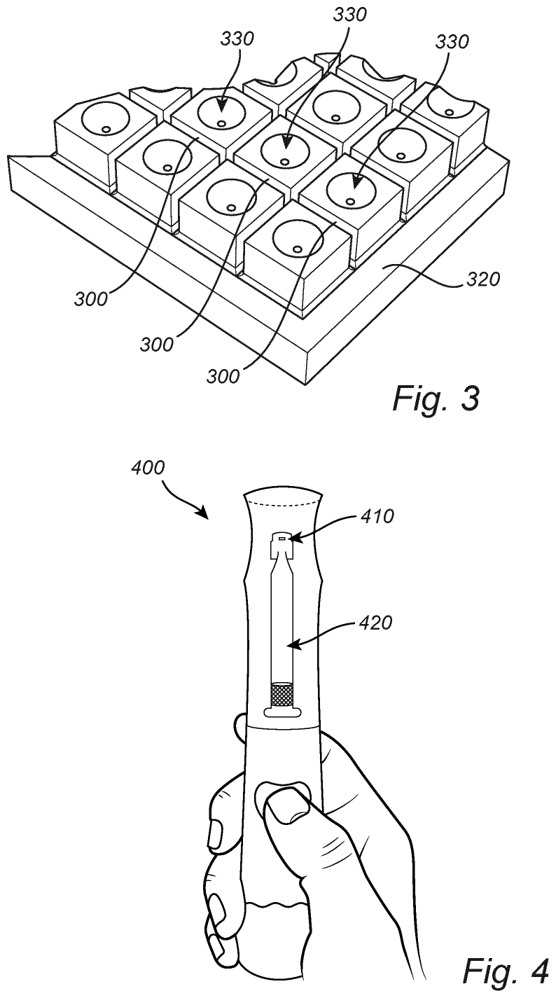

FIG. 3 schematically shows an array of swirl nozzles 300 according to exemplifying embodiments of the present invention, which may be similarly configured as any of the above swirl nozzles described with reference to FIGS. 1 and 2. In FIG. 3, a plurality of swirl nozzles 300 are formed simultaneously and/or in series, by selectively activating multiple voxels at the same time. The swirl nozzles 300 are manufactured on a holder 350, here a glass slide, and fixated by selectively activating voxels in the interface between the swirl nozzle and the holder 350.

FIG. 4 schematically shows a medical device 400 for administering a pharmaceutical drug, comprising a swirl nozzle according to exemplifying embodiments of the present invention. The medical device 400 comprises a swirl nozzle 410 and a container 420 configured to store the pharmaceutical drug, wherein the swirl nozzle 410 is connected to the container 420. The swirl nozzle 410 may be similarly configured as the embodiments discussed above in connection with FIGS. 1-3, and is therefore not described in further detail in connection with the present figure.

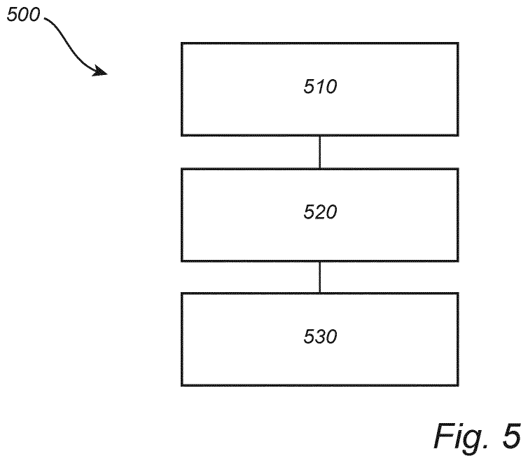

FIG. 5 schematically shows a method 100 for forming a monolithic swirl nozzle as illustrated in FIGS. 1-4, and hence configured to aerosolize a pharmaceutical drug. The swirl nozzle comprises an inlet, a swirl chamber and an outlet as previously described.

The method 500 comprises providing 510 a photoactivatable material and forming the swirl nozzle, by e.g. additive manufacturing, such as 3D printing. The additive manufacturing may comprise selectively activating 520 voxels in the photoactivatable material, which may solidify the selected voxels of the photoactivatable material. An advantageous way to form the swirl nozzle is by selectively activating voxels using two-photon polymerization, TPP, which is a process based on the simultaneous absorption of two photons in the photoactivatable/photosensitive material. The process of TPP typically includes a precise positions stage, lasers to generate e.g. femtosecond pulses in order to activate the photoactivatable material, and a computer to control the process. The forming 520 may be performed on a holder, e.g. a glass slide, wherein the holder is arranged on a positioning stage.

The photoactivatable material may comprise a matrix for suspending materials, such as ceramic or metallic particles. The photoactivatable material may be a polymer, which surprisingly can handle operating pressures of up to bar in these dimensions, e.g. a rectangular swirl nozzle with the dimensions 1 mm×1 mm×0.6 mm.

A plurality of swirl nozzles can be formed in parallel or in series, for instance by activating a plurality of voxels simultaneously. This allows for simultaneous and/or faster manufacturing of a plurality of swirl nozzles. A simultaneous activation of a plurality of voxels may be achieved by a simultaneous control of a plurality of laser beams. The plurality of voxels may be activated in a same swirl nozzle or in different swirl nozzles.

The forming 520 may comprise a first forming stage/step and a second forming stage/step, wherein the first stage comprises forming at least part of the nozzle by selectively activating voxels in the photoactivatable material, and the second forming stage comprises curing a remaining part of the nozzle which was not formed in the first forming stage. The curing may for instance be performed by means of a flush exposure process. By the term “flush exposure” it is here meant exposing the swirl nozzle to a significant amount of light, essentially flushing the swirl nozzle with light and curing any remaining material. The curing may involve curing uncured parts, and/or semi-cured parts of the photoactivatable material trapped inside enclosed volumes in the swirl nozzle.

In FIG. 5, the method 500 further comprises removing 530 non-activated photoactivatable material. The non-activated photoactivatable material may be the photoactivatable material present in voxels which were not selected to be activated. The removing 530 may essentially be a way to wash away excessive photoactivatable material that was not used. The removing 530 may be performed between the first forming stage and the second forming stage, and/or after all forming is performed.

Additionally, variations to the disclosed examples can be understood and effected by the skilled person in practicing the claimed invention, from a study of the drawings, the disclosure, and the appended claims. The mere fact that certain measures are recited in mutually different dependent claims does not indicate that a combination of these measures cannot be used to advantage.

A feature described in relation to one aspect may also be incorporated in other aspects, and the advantage of the feature is applicable to all aspects in which it is incorporated. Other objectives, features, and advantages of the present inventive concept will appear from the detailed disclosure, from the attached claims as well as from the drawings.

Generally, all terms used in the claims are to be interpreted according to their ordinary meaning in the technical field, unless explicitly defined otherwise herein. Further, the use of terms “first”, “second”, and “third”, and the like, herein do not denote any order, quantity, or importance, but rather are used to distinguish one element from another. All references to “a/an/the [element, device, component, means, step, etc.]” are to be interpreted openly as referring to at least one instance of said element, device, component, means, step, etc., unless explicitly stated otherwise. The steps of any method disclosed herein do not have to be performed in the exact order disclosed, unless explicitly stated.

1. A method for forming a swirl nozzle that is monolithic and configured to aerosolize a liquid with a pharmaceutical drug, the swirl nozzle comprising:
an inlet for receiving the pharmaceutical drug to be aerosolized;
a swirl chamber connected to the inlet and configured to aerosolize the pharmaceutical drug provided by the inlet; and
an outlet connected to the swirl chamber and configured to discharge the aerosolized pharmaceutical drug;
the method comprising:
providing a photoactivatable material; and
forming the swirl nozzle by selectively activating voxels in the photoactivatable material.

2. The method according to claim 1, wherein the photoactivatable material comprises a material selected from a list consisting of: polymers, epoxies, ceramics, metals, or composites thereof.

3. (canceled)

4. The method according to claim 1, wherein voxels are selectively activated using two-photon polymerization.

5. (canceled)

6. The method according to claim 1, wherein the swirl nozzle comprises a plurality of inlets.

7. (canceled)

8. The method according to claim 1, wherein the swirl nozzle comprises a plurality of outlets.

9. The method according to claim 1, wherein the outlet comprises an outlet structure with a gradually increasing hydraulic diameter.

10. The method according to claim 1, wherein the swirl chamber comprises channels, wherein the channels are configured to create a swirling motion in a stream of the pharmaceutical drug from the inlet to the outlet, such that the pharmaceutical drug is aerosolized.

11. (canceled)

12. The method according to claim 1, wherein a plurality of voxels are activated simultaneously.

13. (canceled)

14. The method according to claim 1, wherein the forming comprises a first forming stage and a second forming stage, and wherein the first forming stage comprises forming at least part of the swirl nozzle by selectively activating voxels in the photoactivatable material, and the second forming stage comprises an additional curing of the swirl nozzle.

15. The method according to claim 1, wherein the method further comprises removing non-activated photoactivatable material.

16. The method according to claim 1, wherein the method comprises at least one of forming the swirl nozzle on a holder and fixating the swirl nozzle on a holder.

17. (canceled)

18. (canceled)

19. (canceled)

20. The method according to claim 1, wherein selectively activating a voxel in the photoactivatable material comprises exposing the voxel to photons in an ultraviolet range of 100-400 nm.

21. A monolithic swirl nozzle configured to aerosolize a pharmaceutical drug, wherein the swirl nozzle is formed by the method according to claim 1, and the outlet has a diameter in a range of 10-500 μm.

22. The swirl nozzle according to claim 21, wherein the swirl nozzle comprises a width of 4 mm or less.

23. The swirl nozzle according to claim 21, wherein the swirl nozzle comprises a height in a range of 0.1-1 mm.

24. (canceled)

25. The swirl nozzle according to claim 21, wherein the inlet comprises a channel with a height in a range of 20-500 μm.

26. A swirl nozzle that is monolithic and configured to aerosolize a pharmaceutical drug, the swirl nozzle comprising:
an inlet for receiving the pharmaceutical drug to be aerosolized;
a swirl chamber connected to the inlet and configured to aerosolize the pharmaceutical drug provided by the inlet; and
an outlet connected to the swirl chamber and configured to discharge the aerosolized pharmaceutical drug.

27. (canceled)

28. The swirl nozzle according to claim 26, wherein the swirl nozzle is formed of a material selected from a list consisting of: polymers, ceramics, and metals, or composites thereof.

29. The swirl nozzle according to claim 26, wherein a volume of a material forming the swirl nozzle is less than 25 mm³.

30. The swirl nozzle according to claim 26, wherein a maximum outer width of the swirl nozzle is less than 4 mm.

31. (canceled)
